(19) United States
(12) Patent Application Publication
(10) Pub. No.: US 2015/0355023 A1
(43) Pub. Date: Dec. 10, 2015

(54) System and Method of Alignment for Balanced Detection in a Spectral Domain Optical Coherence Tomography

(71) Applicant: Canon Kabushiki Kaisha, Tokyo (JP)

(72) Inventor: Takefumi Ota, Tucson, AZ (US)

(21) Appl. No.: 14/298,682

(22) Filed: Jun. 6, 2014

(51) Int. Cl. G01J 3/02; G01B 9/02; G01J 3/453

(52) U.S. Cl. CPC G01J 3/0275; G01J 3/4535; G01B 9/02091; G01B 9/02041

(57) ABSTRACT

An alignment process for a balance detecting spectral domain optical coherence tomography system. The alignment process includes comparing a spectral performance curve of a first detector array to a spectral performance curve of a second detector array to determine if the system is aligned.

### BACKGROUND

1. Field of Art

The present disclosure is directed towards systems and methods used in spectral domain optical coherence tomography (SD-OCT) in which balanced detection is used.

2. Description of the Related Art

Optical coherence tomography (OCT) is a powerful instrument for imaging objects including biological tissues. Two different types of OCTs are spectral domain OCT (SD-OCT) and a swept source OCT (SS-OCT). A SD-OCT includes a light source with wide spectral range, an interferometer, and a spectrometer. A SS-OCT includes a wavelength scanning light source, an interferometer and a balanced detector.

The balanced detector is used in SS-OCT because it improves the signal to noise ratio (SNR) and the detectors are easy to align. In the prior art balanced detectors have not been successfully used because that would require two spectrometers. In the past, aligning two spectrometers accurately enough to improve the SNR has been difficult to impossible.

What is needed is a SD-OCT with a balanced detector and method of aligning such a system.

### SUMMARY

An exemplary embodiment is an alignment process for a balance detecting spectral domain optical coherence tomography system. The system includes a first detection array, a second detection array; a movable reference mirror, and a reference target. Wherein, each pixel of the detection array measures a different wavelength of interference signals from the reference mirror and the reference target. The process comprises: moving the movable reference mirror from a first position to a second position; measuring a first set of interference signals with the first detector array as the movable reference mirror is moved, wherein each pixel in the first detector array is associated with a first temporal interference signal; measuring a second set of interference signals with the second detector array as the movable reference mirror is moved, wherein each pixel in the second detector array is associated with a second temporal interference signal; performing a spectral transformation of the first temporal interference signal for each pixel associated with the first detector array to produce a third spectral performance curve; performing a spectral transformation of the second temporal interference signal for each pixel associated with the second detector array to produce a fourth spectral performance curve; determining a first set of peak values, wherein each value in the first set of peak values is associated with a peak in the third spectral performance curve for each pixel in the first detector array; determining a second set of peak values, wherein each value in the second set of peak values is associated with a peak in the fourth spectral performance curve for each pixel in the second detector array; comparing the first set of peak values to the second set of peak values to determine if the system is aligned, in the case that the system is determined to be aligned then the alignment process is stopped.

An exemplary embodiment is an alignment process wherein in the case that the system is determined to not be aligned then the alignment process further comprises: adjusting the alignment of the system; moving the movable reference mirror from the first position to the second position; measuring the first set of interference signals with the first detector array as the movable reference mirror is moved, wherein each pixel in the first detector array is associated with the first temporal interference signal; measuring the second set of interference signals with the second detector array as the movable reference mirror is moved, wherein each pixel in the second detector array is associated with the second temporal interference signal; performing the spectral transformation of the first temporal interference signal for each pixel associated with the first detector array to produce the third spectral performance curve; performing the spectral transformation of the second temporal interference signal for each pixel associated with the second detector array to produce the fourth spectral performance curve; determining the first set of peak values, wherein each value in the first set of peak values is associated with the peak in the third spectral performance curve for each pixel in the first detector array; determining the second set of peak values, wherein each value in the second set of peak values is associated with a peak in the fourth spectral performance curve for each pixel in the second detector array; comparing the first set of peak values to the second set of peak values to determine if the system is aligned, in the case that the system is determined to be aligned then the alignment process is stopped. An exemplary embodiment is an alignment process, wherein an amount that the alignment of the system is adjusted is based upon an amount of the result of comparing the first set of peak values to the second set of peak values. An exemplary embodiment is an alignment process, wherein a portion of the system that is adjusted is based upon the results of comparing relative shapes of the first set of peak values to the second set of peak values. An exemplary embodiment is an alignment process, wherein a portion of the system that is adjusted is based upon the results of comparing relative shapes of the first set of peak values and the second set of peak values to an ideal shape.

An exemplary embodiment is an alignment process wherein the spectral transformation is a Fast Fourier Transformation.

An exemplary embodiment is an alignment process further comprising installing a reference target where a measurement target would be located before the alignment is performed and removing the reference target after the alignment is finished.

An exemplary embodiment is an alignment process, further comprising: calculating an alignment parameter that is a function of a difference between the first set of peak values to the second set of peak values; comparing the alignment parameter to a threshold value, in the case that the alignment parameter is less than a threshold value then the system is determined to be aligned.

An exemplary embodiment is an alignment process, wherein the alignment parameter is a sum of an absolute value of a difference between each value of the third spectral performance curve and the fourth spectral performance curve.

Further features and aspects will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments.

FIG. 1 is an illustration of a first embodiment of a SD-OCT with balanced detection.

FIG. 2 is an illustration of a second embodiment of a SD-OCT with balanced detection.

FIG. 3 is an illustration of a third embodiment of a SD-OCT with balanced detection.

FIG. 4 is an illustration of a fourth embodiment of a SD-OCT with balanced detection.

FIG. 5 is an illustration of an alignment process.

FIGS. 6A-B are illustrations of data produced during the alignment process.

### DESCRIPTION OF THE EMBODIMENTS

Embodiments will be described below with reference to the attached drawings. SD-OCT with balanced detection

### First Exemplary Embodiment

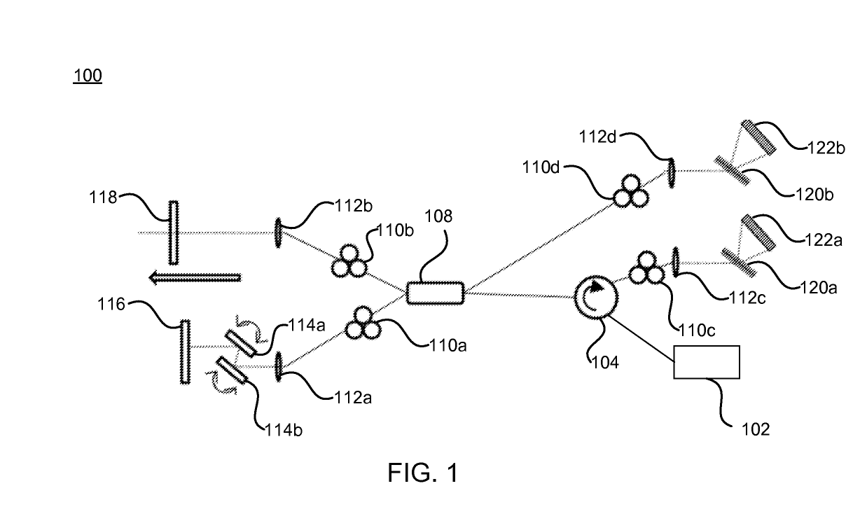

An embodiment of the alignment process may be implemented in the context of a SD-OCT with balanced detection (BD-SD-OCT) 100 such as the one illustrated in FIG. 1. This alignment process can be applied to not only a BD-SD-OCT but also to spectrometers that include balanced detector arrays.

In FIG. 1, the BD-SD-OCT 100 uses optical fibers components, however free space optics may be used instead for one or more of the optical fibers components. The BD-SD-OCT 100 is an imaging apparatus 100. Apparatus 100 uses a broadband light source 102 with a bandwidth of 10 nm, 100 nm, 200 nm, 500 nm 1000 nm or 200 nm. The broadband light source 102 may be based on semiconductor, fiber optics, lamps, and/or solid state crystals. An example of the broadband light source 102 is a super luminescent diode.

The broadband light source 102 is coupled to a first port of a circulator 104. Both the circulator 104 and the broadband light source 102 may be fiber coupled or free space components. An isolator 106 (not shown) may be inserted between the circulator 104 and the broadband light source 102. The isolator 106 may improve the RIN noise of the broadband light source 102. Light from the first port of the circulator 104 couples the light to the second port of the circulator 104.

Light from the second port of the circulator 104 is coupled into a first port of the fused fiber coupler 108. Light from the first port of the fused fiber coupler 108 is divided into two beams of light and is coupled to a second port and a third port of the fused fiber coupler 108. Light from the second port of the fused fiber coupler 108 is passed through a first polarization controller 110a and exits a first lens 112a as a measurement beam. Light from the third port of the fused fiber coupler 108 is passed through a second polarization controller 110b and exits a second lens 112b as a reference beam.

The measurement beam exiting the first lens 112a is then scanned by a first scanner 114a and a second scanner 114b across a measurement target 116. The first scanner 114a and the second scanner 114b can be combined into a single scanner. The scattered and reflected light from the measurement target 116 passes back through the first scanner 114a, the second scanner 114b, first lens 112a, a first polarization controller 110a and back into the second port of the fused fiber coupler 108. In an alternative embodiment, the scanners 114a-b are removed or kept still and the measurement target 116 is moved instead. In another alternative embodiment, both the scanners 114a-b and the measurement target 116 are moved.

The reference beam exiting the second lens 112b is reflected off a reference mirror 118. The reference mirror 118 may be translated along the optical axis of the second lens 112b during the measurement process. The light reflected off the reference mirror 118 passes back through the second lens 112b, polarization controller 110b and back into the third port of the fused fiber coupler 108.

The fused fiber coupler 108 mixes the light that enters from the second port and third port of the fused fiber coupler 108 and couples the mixed interference light into both the first port of the fused fiber coupler 108 and a fourth port of the fused fiber coupler 108.

Light that exits the first port of the fused fiber coupler 108 is coupled into the second port of the circulator 104. Light that exits the second port of the circulator 104 is then coupled out of a third port of the circulator 104 and passes through a third polarization controller 110c and a third lens 112c. Light exiting the third lens 112c is incident on a first diffraction grating 120a. The first diffraction grating 120a diffracts the light which is then incident upon a first detector 122a.

Light that exits the fourth port of the fused fiber coupler 108 passes through a fourth polarization controller 110d and a fourth lens 112d. Light exiting the fourth lens 112d is incident on a second diffraction grating 120b. The second diffraction grating 120b diffracts the light which is then incident upon a second detector 122b.

The fused fiber coupler 108 and/or the polarization controllers 110a-d may be replaced with free space optical components. The lenses 112a-d may be fiber coupled GRIN lenses which substantially collimate the light exiting the lenses. The diffraction gratings 120a-b may be transmission gratings or reflection gratings. The detectors 122a-b may be linear detectors arrays or 2-D detector array that is operated as a 1-D detector array. A slit or aperture may be placed between the diffraction gratings and the detectors. The diffraction gratings may also be 120a-b other optical components which spatially disperse light such as a prism.

### Second Exemplary Embodiment

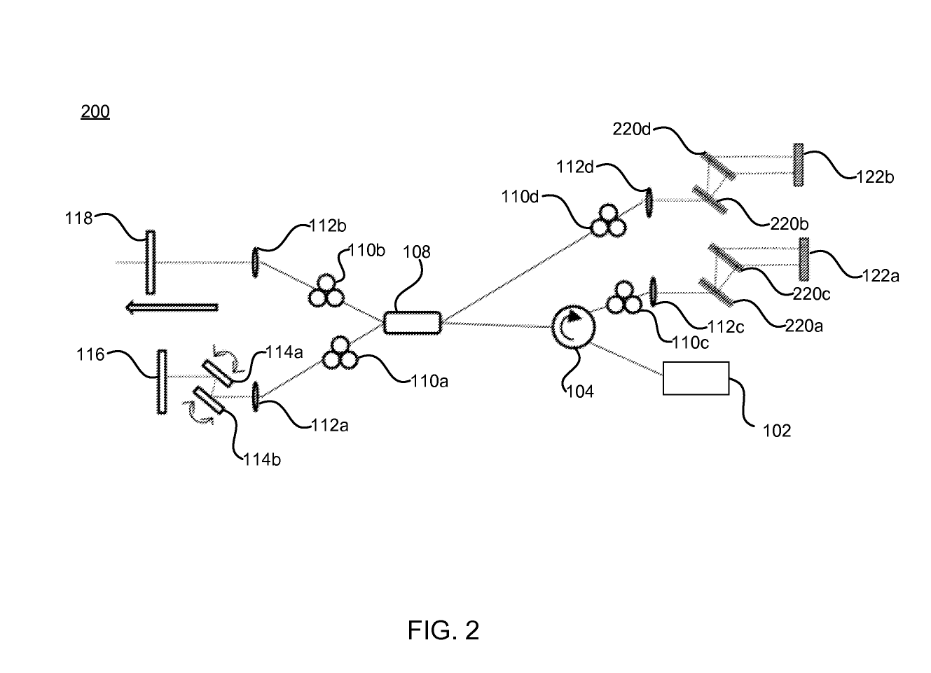

A second exemplary embodiment 200 is described with reference to FIG. 2. Configurations common to those of the first embodiment will be denoted by the same reference numerals as those of the first embodiment and the description thereof will be omitted.

The second exemplary embodiment 200 is identical the first exemplary embodiment 100 except that the first diffraction grating 120a is replaced with a first diffraction grating 220a and a third diffraction grating 220c and the second diffraction grating 120b is replaced with a second diffraction grating 220b and a fourth diffraction grating 220d. The first and third diffraction gratings are arranged to spatially disperse the different wavelengths of light across the first detector 122a wherein the different wavelengths of light are collinear to each other. The second and fourth diffraction gratings are arranged to spatially disperse the different wavelengths of light across the second detector 122b wherein the different wavelengths of light are collinear to each other. This arrangement can improve the linearity of the detectors 122a-b.

### Third Exemplary Embodiment

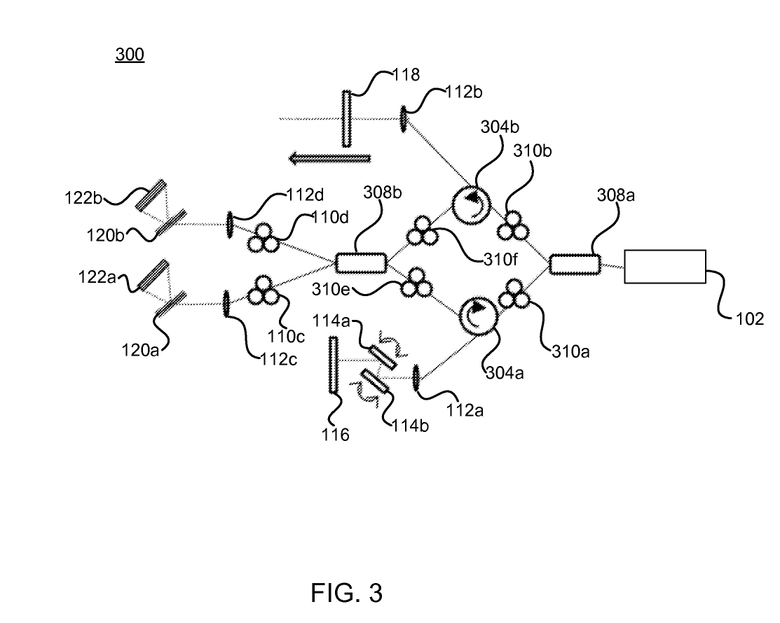

A third exemplary embodiment 300 is described with reference to FIG. 3. Configurations common to those of the first embodiment will be denoted by the same reference numerals as those of the first embodiment and the description thereof will be omitted.

The broadband light source 102 is coupled into a first port of the first fused fiber coupler 308a. Light from the first port of the first fused fiber coupler 308a is divided into two beams of light which is coupled into a second port and a third port of the fused fiber coupler 308a. Light from the second port of the first fused fiber coupler 308a is passed through a first polarization controller 310a and is coupled into a first port of a first circulator 304a. Light from the first port of the first circulator 304a is coupled into the second port of the first circulator 304a. Light from the third port of the first fused fiber coupler 308a is passed through a second polarization controller 310a and is coupled into a first port of a second circulator 304b. Light from the first port of the second circulator 304b is coupled into the second port of the second circulator 304b.

Light from the second port of the first circulator 304a exits a first lens 112a as a measurement beam. The measurement beam exiting the first lens 112a is then scanned by a first scanner 114a and a second scanner 114b across a measurement target 116. The first scanner 114a and the second scanner 114b can be combined into a single scanner. The scattered and reflected light from the measurement target 116 passes back through the first scanner 114a, the second scanner 114b, first lens 112a, and back into the second port of the first circulator 304a. Light from the second port of the first circulator 304a is coupled into the third port of the first circulator 304a. Light from the third port of first circulator 304a is passed through a fifth polarization controller 310e and is coupled into a first port of a second fused fiber coupler 308b.

Light from the second port of the second circulator 304a exits a second lens 112b as a reference beam. The reference beam exiting the second lens 112b is reflected off a reference mirror 118. The reference mirror 118 may be translated along the optical axis of the second lens 112b during the measurement process. The light reflected off the reference mirror 118 passes back through the second lens 112b and back into the second port of the second circulator 304b. Light from the second port of the second circulator 304b is coupled into a third port of the second circulator 304b. Light from the third port of the second circulator 304b is passed through a sixth polarization controller 310f and is coupled into a second port of the second fused fiber coupler 308b.

The second fused fiber coupler 308b mixes the light that enters from the first port of the second fused fiber coupler 308b and the second port of the second fused fiber coupler 308b and couples the mixed interference light into both a third port of the second fused fiber coupler 308b and a fourth port of the second fused fiber coupler 308b.

Light that exits the third port of the second fused fiber coupler 308b passes through a third polarization controller 110c and a third lens 112c. Light exiting the third lens 112c is incident on a first diffraction grating 120a. The first diffraction grating 120a diffracts the light which is then incident upon a first detector 122a.

Light that exits the fourth port of the fused fiber coupler 108 passes through a fourth polarization controller 110d and a fourth lens 112d. Light exiting the fourth lens 112d is incident on a second diffraction grating 120b. The second diffraction grating 120b diffracts the light which is then incident upon a second detector 122b.

### Fourth Exemplary Embodiment

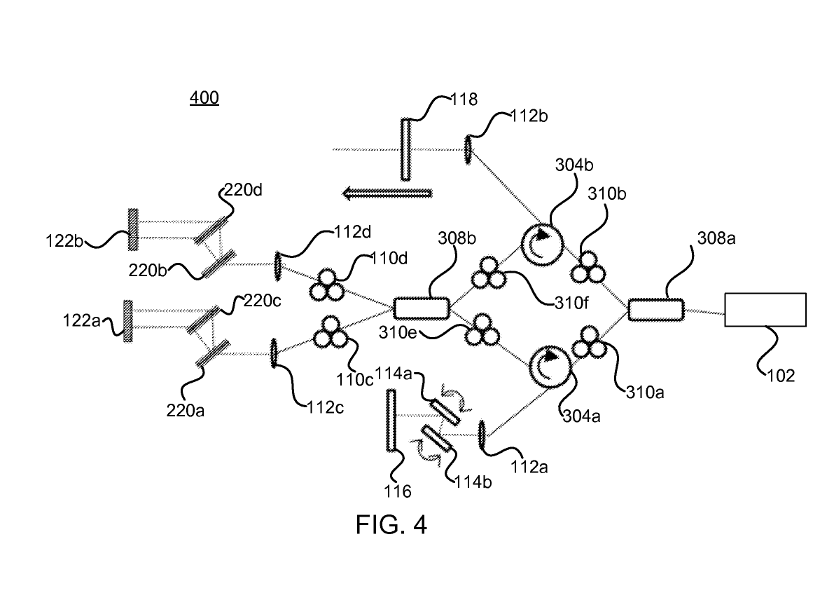

A fourth exemplary embodiment 400 is described with reference to FIG. 4. Configurations common to those of the second and third embodiments will be denoted by the same reference numerals as those of the first embodiment and the description thereof will be omitted.

The fourth exemplary embodiment 400 is identical the third exemplary embodiment 300 except that the first diffraction grating 120a is replaced with a first diffraction grating 220a and third diffraction grating 220c and the second diffraction grating 120b is replaced with a second diffraction grating 220b and a fourth diffraction grating 220d.

### Common Features of the Exemplary Embodiments

All of the embodiments 100, 200, 300 and 400 include two sets of detectors 122a-b. An analog/digital (ND) converter is connected to the detectors 122a-b to convert the analog signals produced by the detectors. The digital signals are then processed by a processor, the processor may be a graphics processing unit (GPU), a central processing unit (CPU), a digital signal processor (DSP), general purpose processor, or an application specific processor.

### Process

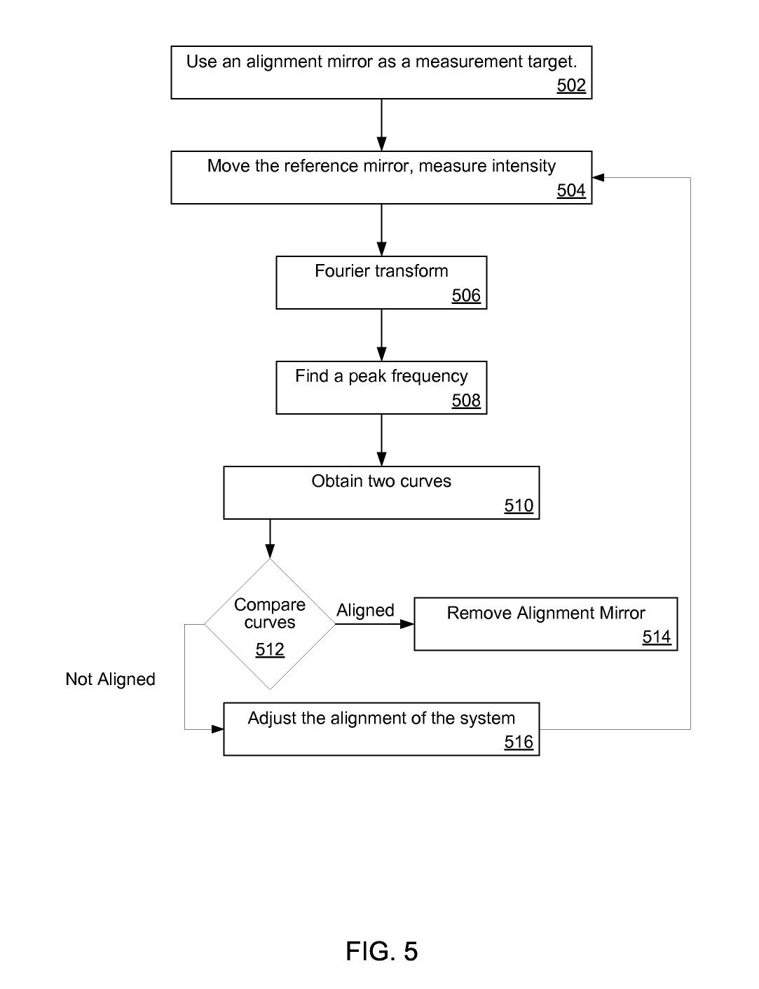

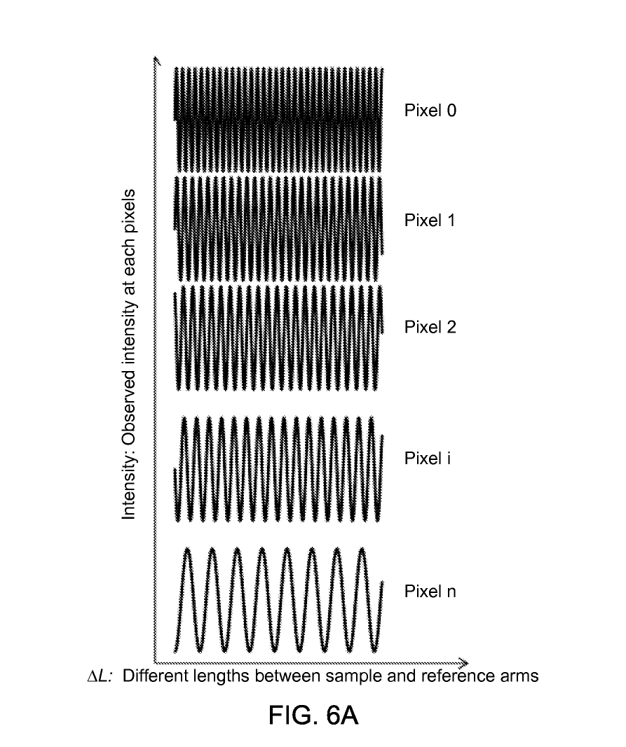

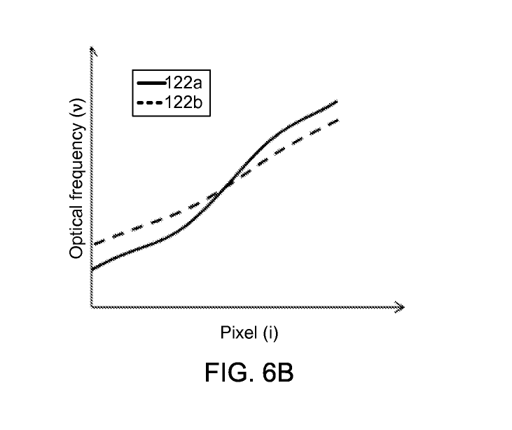

FIG. 5 is an illustration of an alignment process 500 for aligning a BD-SD-OCT such as the exemplary embodiments 100, 200, 300, 400. In a step 502, a reference target such as an alignment mirror is used as a measurement target 116. In a step 504, the reference mirror 118 is translated along the optical axis of the second lens 112b. As the reference mirror 118 is being translated the intensity at each pixel of the detectors 122a-b are measured. The interference signal intensity I at each pixel i is a function can be expressed by Equation 1 and is illustrated in FIG. 6A.

$${I}_{i} = sin \frac{Δ {Lv}_{i}}{c} \qquad ( 1 )$$

FIG. 6A is an illustration of the intensity of light observed at each pixel of the detectors 122a-b in an n pixel array including 0, 1, 2, i . . . n pixels. The speed of light c in the medium of the reference arms and measurement arms of the BD-SD-OCT. There is a sinusoidal relationship between each pixel and the relative difference ΔL between sample arm and the reference arm. The frequency of this relationship is proportional to the frequency of the center frequency vᵢ of the light measured by the pixel as illustrated in FIG. 6. Each pixel is primarily associated with a limited range of frequencies.

In a step 506 a Fourier transform is applied to the intensity Iᵢ observed at each pixel to obtain a frequency spectrum of the intensity data at each pixel as illustrated in equation 2. The Fast Fourier Transform may be used to perform the Fourier transform, other transformation techniques may be used to obtain the frequency spectrum or a spectral equivalent of the intensity data. Under ideal conditions, the frequency spectrum of the intensity data at each pixel is a delta function at the center frequency vᵢ.

$$ℱ ( {I}_{i} ( Δ L ) ) = δ ( \frac{v - {v}_{i}}{c} ) \qquad ( 2 )$$

Under real world conditions, the result of the Fourier transform is not a delta function. In a step 508 a peak value or maximum value search routine may be used to obtain the center frequency vᵢ at pixel i as described in equation (3)

vᵢ∝peak(F(Iᵢ(ΔL))) (3)

The center frequency vᵢ is determined in a step 510 for each pixel of the detectors 122a-b to obtain two curves vₐ(i) and v_{b}(i) which are illustrated in FIG. 6B. The two curves are compared in a step 512. In a perfectly aligned system, the two curves vₐ(i) and v_{b}(i) are identical. In a real world system, when the difference between the two curves is less than a tolerance then the system may be considered to be aligned. The comparison may be done by displaying the two curves vₐ(i) and v_{b}(i) and having a user make a judgment as to the alignment of the system. In order to aid in the alignment a tolerance variable X may be calculated using equation (4) which is then compared to a tolerance limit Xₗᵢₘ. Other statistical techniques well known in the art may be used to compare the two curves.

$$𝒳 = {\sum }_{i = 0}^{n} \vert {v}_{a} ( i ) - {v}_{b} ( i ) \vert \qquad ( 4 )$$

If the system is determined to be aligned in a step 512 then it proceeds to a step 514 in which the alignment mirror is removed and the alignment process 500 is finished. If the system is determined to not be aligned in a step 512 then the alignment of the system is adjusted in a step 516. During the step 516 the magnitude of the tolerance variable X may be used to determine the magnitude of the adjustment. The relative shapes of the two curves vₐ(i) and v_{b}(i) to each other may be used to determine which part of the system is adjusted during step 516. The absolute shape of the two curves vₐ(i) and v_{b}(i) relative to an ideal shape may also be used to determine which part of the system is adjusted during step 516. After the alignment of the system is adjusted then process returns to step 504 and continues with alignment process described above until the system has been aligned.

A fitting function can be applied to the two curves vₐ(i) and v_{b}(i). The fitting function may be a high order linear function or any other preferred function. This fitting function is used as a correction function and for resampling the interference spectral data in a specified k-space before applying the Fourier transform.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

What is claimed is:

1. An alignment process for a balance detecting spectral domain optical coherence tomography system, the system includes a first detection array, a second detection array; a movable reference mirror, a reference target, wherein each pixel of the detection array measures a different wavelength of interference signals from the reference mirror and the reference target, the process comprising:
moving the movable reference mirror from a first position to a second position;
measuring a first set of interference signals with the first detector array as the movable reference mirror is moved, wherein each pixel in the first detector array is associated with a first temporal interference signal;
measuring a second set of interference signals with the second detector array as the movable reference mirror is moved, wherein each pixel in the second detector array is associated with a second temporal interference signal;
performing a spectral transformation of the first temporal interference signal for each pixel associated with the first detector array to produce a third spectral performance curve;
performing a spectral transformation of the second temporal interference signal for each pixel associated with the second detector array to produce a fourth spectral performance curve; and
determining a first set of peak values, wherein each value in the first set of peak values is associated with a peak in the third spectral performance curve for each pixel in the first detector array;
determining a second set of peak values, wherein each value in the second set of peak values is associated with a peak in the fourth spectral performance curve for each pixel in the second detector array;
comparing the first set of peak values to the second set of peak values to determine if the system is aligned, in the case that the system is determined to be aligned then the alignment process is stopped.

2. The alignment process of claim 1, wherein in the case that the system is determined to not be aligned then the alignment process further comprises:
adjusting the alignment of the system;
moving the movable reference mirror from the first position to the second position;
measuring the first set of interference signals with the first detector array as the movable reference mirror is moved, wherein each pixel in the first detector array is associated with the first temporal interference signal;
measuring the second set of interference signals with the second detector array as the movable reference mirror is moved, wherein each pixel in the second detector array is associated with the second temporal interference signal;
performing the spectral transformation of the first temporal interference signal for each pixel associated with the first detector array to produce the third spectral performance curve;
performing the spectral transformation of the second temporal interference signal for each pixel associated with the second detector array to produce the fourth spectral performance curve; and
determining the first set of peak values, wherein each value in the first set of peak values is associated with the peak in the third spectral performance curve for each pixel in the first detector array;
determining the second set of peak values, wherein each value in the second set of peak values is associated with a peak in the fourth spectral performance curve for each pixel in the second detector array;
comparing the first set of peak values to the second set of peak values to determine if the system is aligned, in the case that the system is determined to be aligned then the alignment process is stopped.

3. The alignment process of claim 1, wherein the spectral transformation is a fast Fourier transformation.

4. The alignment process of claim 1, further comprising installing a reference target where a measurement target would be located before the alignment is performed and removing the reference target after the alignment is finished.

5. The alignment process of claim 1, further comprises:
calculating an alignment parameter that is a function of a difference between the first set of peak values to the second set of peak values; and
comparing the alignment parameter to a threshold value, in the case that the alignment parameter is less than a threshold value then the system is determined to be aligned.

6. The alignment process of claim 5, wherein the alignment parameter is a sum of an absolute value of a difference between each value of the first set of peak values and the second set of peak values.

7. The alignment process of claim 2, wherein an amount that the alignment of the system is adjusted is based upon an amount of the result of comparing the first set of peak values to the second set of peak values.

8. The alignment process of claim 2, wherein a portion of the system that is adjusted is based upon the results of comparing relative shapes of the first set of peak values to the second set of peak values.

9. The alignment process of claim 2, wherein a portion of the system that is adjusted is based upon the results of comparing relative shapes of the first set of peak values and the second set of peak values to an ideal shape.
